(19) United States
(12) Patent Application Publication
(10) Pub. No.: US 2012/0031524 A1
(43) Pub. Date: Feb. 9, 2012

(54) VESSEL ADAPTED TO BE USED AS A MOVEABLE BOTTLING PLANT FOR BOTTLING LIQUID PRODUCTS

(75) Inventors: Kjartan Ragnarsson, Vogar (IS); Ómar Már Jónsson, Sudavik (IS)

(73) Assignee: ICELANDIC WATER LINE LTD., Reykjanesbæ (DK)

(21) Appl. No.: 13/262,494

(22) PCT Filed: Mar. 31, 2010
(86) PCT No.: PCT/EP10/54296

§ 371 Date: Oct. 19, 2011

Related U.S. Application Data
(60) Provisional application No. 61/166,623, filed on Apr. 3, 2009.

(30) Foreign Application Priority Data
Apr. 3, 2009 (EP) 09157291.7
Sep. 25, 2009 (EP) 09171327.1

(51) Int. Cl. B65B 3/00; B65G 67/60; B65B 3/04

(52) U.S. Cl. 141/1; 141/98; 141/94; 414/140.8

(57) ABSTRACT

This invention relates to a vessel (100) adapted to be used as a moveable bottling plant for bottling liquid products, where means (112a-112d) for hosting liquid products and means for hosting empty receptacles (128) or ingredients adapted for producing such receptacles is provided. A communication means (102) is provided for receiving external orders (107-109) from external liquid buyer (104-106) for bottling the liquid into the receptacles. A liquid bottling line (122) is provided for bottling the liquid on board of the vessel in accordance to the received external orders.

### FIELD OF THE INVENTION

The present invention relates to a vessel adapted to be used as a moveable bottling plant bottling liquid products, and to a method performed on board of such a moveable bottling plant of bottling liquid products.

### BACKGROUND OF THE INVENTION

Imagine that a water buyer wants to export water from a first location to a second location. The first obvious option is simply to bottle the water at the first location and transport the bottled water to the second location. If the distance between these locations is large and the market at the second location is very large, it may be favourable to simply set up a bottling plant at the second location. In that way, the transport costs may be reduced, but in turn the fixed costs are increased due to the costs involved in setting up and running the new bottling factory. As an example, the first location may be Iceland and the second location be USA. Building a new water plant in USA that is supposed to bottle Icelandic high quality water has the drawback that the Icelandic water must still be exported from Iceland to USA in a container or similar means. Such a transport is however almost impossible due to the large weight of the water and also the costs and difficulties involved in making such a transport. Accordingly, the only option that is kept open is to bottle the water in Iceland and export the bottled water to USA. Although the cost per bottle in Iceland is relatively cheap, it is too high when it enters the shops in the USA due to all the transport costs.

Other scenarios that are worth considering is third world region where there is an urgent need for a water, but due to high costs involved in transporting the water to these regions only a limited amount of water can be transported, an amount which is far from being sufficient.

Accordingly, there is a need for improved ways of bottling water and other liquids that make such a bottling more economical.

### SUMMARY DESCRIPTION OF THE INVENTION

The object of the present invention is to overcome the above mentioned drawbacks by providing new and an improved way of bottling liquid products which makes it possible to transport the bottled liquid to a world wide market with a cost which is only a fraction of the costs using the today's transport methods.

According to a first aspect the present invention relates to a vessel adapted to be used as a moveable bottling plant for bottling liquid products, the vessel comprising:
means for hosting liquid products,
means for hosting empty receptacles or ingredients adapted for producing such receptacles,
a communication means adapted to receive external orders from external liquid buyer for bottling the liquid into the receptacles, and
a liquid bottling line adapted to bottle the liquid on board of the vessel in accordance to the received external orders.

Accordingly, a moveable bottling plant is provided which makes it possible to receive external orders of bottling certain amount of liquid such as water, labeled with e.g. the buyer's trademark, where the vessel may at the same time acts as a factory for producing the receptacles such as plastic bottles in accordance to received orders from the bottles such as water bottles. Subsequently, the bottled and labeled receptacles are transported with the vessel to all destination addresses. The vessel will have a possibility to make all kind of receptacles and labeled with trademarks based on the received orders. With the term receptacle is meant any type of bottles, glass bottles, plastic bottles, cans, aluminium and aluminium alloy cans and the like.

Referring to the example above, the liquid product could be Icelandic water where the vessel is adapted to receive orders, from e.g. a buyer in USA. Thus, instead of building a new factory in USA the bottling and the transporting becomes integrated into the vessel. The external orders could just as well be orders from other water buyers that want to sell the water under their own trademark.

Additionally, all the costs involved in e.g. building and running bottling plants in each unloading harbor, for water transported by container ship and tankers (building costs, fixed costs, cost of employee, property-related costs such as rent and other fees) are eliminated since the transport of the bottled liquid as well as the bottling itself is combined into the vessel. The transport costs are strongly reduced because the bottling plant is running when loading, on sailing, and when unloading is made in end destination e.g. from Iceland to Netherlands-Portugal-Guinea-Australia-New York-China and more.

In one embodiment, the communication means is a computer system including a receiver for receiving the external orders, where the external orders include:
information indicating the type of liquid to be bottled,
information relating to the label with trademark to be put on the receptacle,
information indicating the destination of the bottled liquid,
information indicating the volume of the receptacles and the type of liquid to be bottled,
information indicating the external shape the receptacles,
barcoding including information indicating the retail price of the receptacle
a combination of one or more of the above.

It follows that it is possible to specify in details the orders, e.g. what type of liquid, the size/shape of the receptacles, which can e.g. be plastic or glass bottles to be used, whether the receptacles should be labeled on board or not, and the destination address. As an example, the external orders could include details about the label, the trademark, i.e. a complete label that is to be put on the receptacle. Thus, when the vessel containing the bottled liquid product arrives at the destination the receptacles are unloaded from the vessel and are ready to be transported directly to the stores if they already possess the label with the trademark as well as the barcoding necessary to indicate the retail price of the receptacle.

In one embodiment, the liquid product is selected from one or more of the following:
a water,
a soda water,
an alcohol containing drink,
a juice,
a food oil,
a beer,
a fish oil,
a soda cola, and
a soft drink.

The vessel can thus be used as a bottling plant for all kind of liquids and even two or more type of liquids. Thus, the vessel can be adapted to bottle water and/or juice and/or beer and more at the same time.

In one embodiment, said means for hosting the liquid products comprises multiple tanks arranged within the hold of the vessel (i.e. the moveable bottling plant). This may be compared to oil ships where the oil is kept within the hold of the vessel, but instead of oil, the liquid products are kept within there. This thus provides the possibility of changing such oil ships or other type of ships into such a vessel to be used as a moveable bottling plant.

In one embodiment, the vessel comprises a first deck as a top deck, a second deck comprising one or more unloading hatches for hosting bottled liquid that is ready to deliver to the buyers of the liquid and a third deck for hosting liquid bottling line. In one embodiment, the third deck further comprises one or more production lines selected from:
receptacle production line adapted for producing the receptacles in accordance with the received orders from the buyers,
a blowing factory adapted for producing the receptacles in accordance with the received orders from the buyers,
tap production line adapted for producing the taps for the receptacles in accordance with the received orders from the buyers,
label production line adapted for producing the labels along with the trademark in accordance with the received orders from the buyers,
euro plastic pallets and plastic film production for packing.

In another embodiment, the vessel comprises a first deck as a top deck, a second deck for hosting liquid bottling line, a third deck for hosting ready liquid products and a fourth deck for hosting ready liquid products and one or more unloading hatches for unloading the ready liquid products. In one embodiment, the third deck further comprises one or more of said production lines selected from:
receptacle production line adapted for producing the receptacles in accordance to the received orders from the buyers,
a blowing factory adapted for producing the receptacles in accordance to the received orders from the buyers,
tap production line adapted for producing the taps for the receptacles in accordance to the received orders from the buyers,
label production line adapted for producing the labels along with the trademark in accordance to the received orders from the buyers,
euro plastic pallets and plastic film production for packing.

The vessel thus does not only act as a bottling plant, but also as a factory that is capable of producing the ingredients necessary for producing the receptacles as well as a factory for producing the receptacles as well as the shape of the receptacles and the tabs for the receptacles in accordance to the received orders for the buyers.

In one embodiment, a special made water controllizer IWL 20-200 is mixed with the hosting liquid products so as to maintain pureness of the means for hosting liquid products. This chemical has the properties that it reacts immediately when bacterium is formed within the containers, otherwise it has no effect. Thus, it is ensured that the means for hosting the liquid is clean at all times.

In one embodiment, the means for hosting the ingredients adapted for producing the receptacles is a tank arranged within the hold of the vessel and where the ingredient includes the raw material adapted to be used for producing the plastic material for producing plastic receptacles. Such a raw material includes as an example raw oil and other necessary and well knows ingredients needed to product the necessary material.

In one embodiment, the vessel further comprises a cooling mechanism integrated into the means for hosting liquid products for maintaining the liquid products below a pre-defined temperature. This temperature typically depends on the type of liquid products and may as an example be in the range of 1-10° C. for water.

In one embodiment, the liquid product is water processed from a see water and where an excess energy from the engine of the vessel is used to vacuum distillation the see water and convert it to drinkable water. In that way, the enormous excess energy from the engine of the vessel that can be up to 66% of the total horse powers is used to vacuum distillation the water and thus convert it into drinkable water, and the energy used to drive the vessel can be 34%. This is an environmental way of using the energy and obviously an enormous cost reduction and makes it possible to e.g. ship water to third world countries in a very economical way. Thus, this vessel will be able to contribute enormously shipping water to e.g. third world countries and other countries where there is a great need for water and where the financial resources are limited.

Other energy supplies could additionally be provided on board for the ship to participate in this cleaning process, such as solar cells.

According to another aspect, the present invention relates to a conveyor system adapted to convey bottles liquid from said vessel to a destination harbour r, comprising:
a horizontal conveyor portion that defines a horizontal conveying path, and
a vertical conveyor portion adapted to be interlinked to the horizontal conveyor portion that defines a vertical conveying path,
   wherein during use the horizontal and the vertical conveyor portions form a step-like conveyor, the first horizontal conveyor portion being adapted to be coupled to said one or more unloading hatches of the vessel and extends away from the vessel towards the harbour
   r and where the vertical conveyor portion forms a vertical extension from the end of first conveyor portion to the harbour
   r, where the conveyor portions comprise multiple forks that move along a closed loop conveying path defined via the conveyor portions such that forks interact with pallets or similar means that carry the bottled liquid products and convey the liquid bottled products out of the hatches along the horizontal conveying path and subsequently along the vertical conveying path where the bottles liquid is released.

Thus, an highly advantage conveying system is provided that is capable of conveying the bottled liquid products out of the vessel to the harbour at the destination addresses in a very convenient and effective way. Also, it should be noted that by reducing the loading time the cost per bottle is further reduced since the longer the vessel is at the harbour the more fees (harbour related fees) need to be paid.

In one embodiment, the conveyor system is an integral part of the vessel, or is kept separately on shore.

In one embodiment, the horizontal and the vertical conveyor portions may be clamped together when not being used.

In one embodiment, the conveyor system further comprises a third conveyor portion adapted to be connected to the second conveyor portion for conveying the received bottled liquid products from the second conveyor portion. In that way, the pallets containing the bottled liquid products can be conveyed directly into e.g. a container, a truck etc.

According to another aspect, the present invention relates to a method performed on board on said vessel acting as a moveable bottling plant for bottling liquid products, comprising:
receiving orders from external liquid buyers for bottling the liquid into the receptacles the orders including information indicating the type of liquid to be bottled and information indicating the destination of the bottled liquid,
bottling the liquid on board of the vessel in accordance to the received external orders in accordance to the received orders.

In one embodiment, external orders include:
information indicating the type of liquid to be bottled,
information relating to the label with Trademark to be put on the receptacle,
information indicating the destination of the bottled liquid,
information indicating the volume of the receptacles
information indicating the external shape the receptacles.

The aspects of the present invention may each be combined with any of the other aspects. These and other aspects of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 shows one embodiment of a vessel according to the present invention adapted to be used as a bottling plant for bottling liquid products,

FIG. 2 show a top view of a second deck of the vessel shown in FIG. 1,

FIG. 3 shows a conveyor system adapted to convey bottles liquid from the vessel as claimed in any of the preceding claims to a destination harbour,

FIG. 4 shows another embodiment of a vessel according to the present invention,

FIG. 5 shows a conveyor system during use for conveying the bottled liquid products from the second deck in the vessel to a harbour r at the destination address,

FIG. 6 shows an example of possible route of a vessel where the vessel receives orders from one or more liquid buyers for bottling liquid, and

FIG. 7 an embodiment of a method according to the present invention bottling liquid products on board of the vessel in FIG. 1.

### DESCRIPTION OF EMBODIMENTS

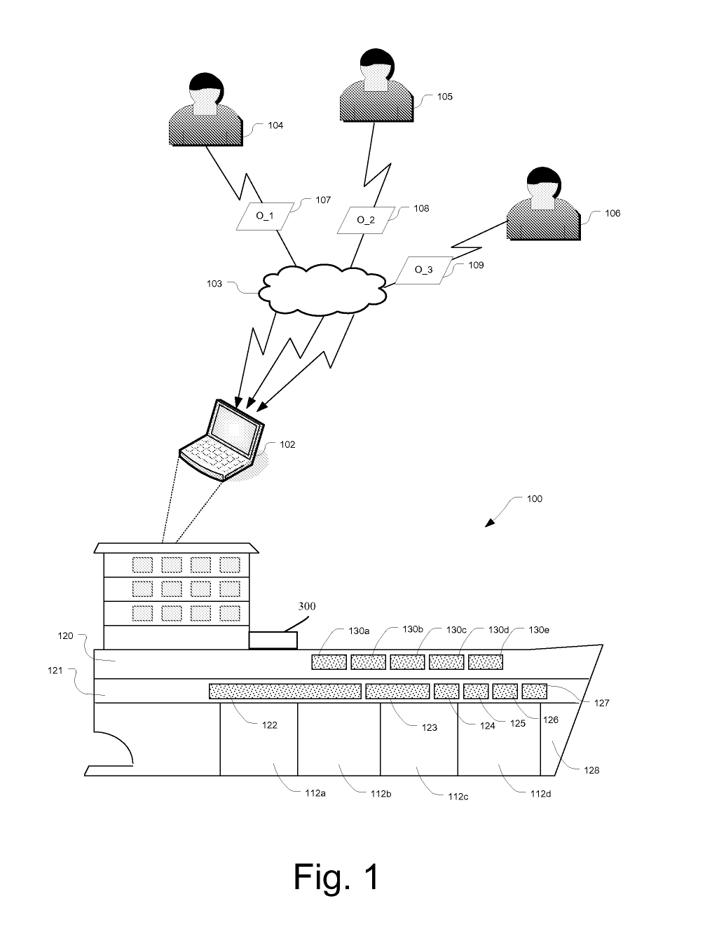

FIG. 1 shows a vessel 100, according to the present invention adapted to be used as a bottling plant for bottling liquid products. The vessel 100, comprises means such as store tanks for hosting liquid products 112, means for hosting empty receptacles or ingredients adapted for producing such receptacles 128, a communication means 102 adapted to receive external orders 107-109, from external liquid buyers 104-106, for bottling the liquid into the receptacles via a wireless communication channel 103 (e.g. via satellite connection, or Internet), and a liquid bottling line 122, adapted to bottle the liquid on board of the vessel 100, in accordance to the received external orders 107-109.

By the term vessel 100 is meant a ship or a factory ship or a boat or similar means of any type and size that acts as a moveable bottling factory, where the size depends on the production volume required by the vessel 100. By the term receptacle is meant any kind of bottles or cans and the like made of plastic, glass, aluminium or aluminium alloy of any type.

The means for hosting the liquid products 112a-112d is in the hold of the vessel 100 and comprises a container or a tank or similar means adapted for hosting the liquid products. The liquid products may e.g. be, water, a soda water, an alcohol containing drink, a juice, food oil, a beer, a fish oil, a soda cola, a soft drink and the like. As depicted here, the means for hosting the liquid 112a-112d consists of, but is not limited too, four tanks but these tanks may contain one type of a liquid product or two or more different types of different liquid products.

The liquid products may be obtained at various places and e.g. be collected at some given harbour where said liquid products are collected, e.g. by pumping water form a given harbour and into said tanks 112a-112d.

Also, if the liquid product is water, it may be processed from a see water where the vessel 100 may further be provided with a pump (not shown) that pumps see water into vacuum distillation system and then into one or more of said tanks 112a-112d, or into an intermediate tank (not shown). The see water is vacuum distillate onboard with the appropriate vacuum distillation mechanism. The energy required to vacuum distillation the water may be an excess energy from the engines of the vessel is used to vacuum distillation the see water and convert it to a drinkable water, and also using solar sells where the solar energy may be used as an additional energy supply to vacuum distillation the water.

The vessel may further be provided with a brewing system (not shown) for brewing any types of alcohol containing drinks such as beer, and liquor.

Further, in one embodiment the liquid product further contains a special made, water controllizer, IWL 20-200 which is mixed with the hosting liquid products while the pureness of the means for hosting liquid products (container) is maintained. This chemical has the properties that it reacts immediately when bacterium is formed within the containers, otherwise it has no effect and is drinkable when mixed in the correct amount.

In the embodiment shown here, the vessel 100 is separated into three decks, a first deck that is the top of the vessel 100 where an unloading conveyer system 300 may be kept, a second deck 120 comprising one or more unloading hatches 130a-130e for hosting bottled liquid that is ready to deliver to the buyers of the liquid and a third deck 121 for hosting liquid bottling line 122. It should be noted that the number of hosting tanks 112a-112d is not limited to four tanks, and the number of decks is not limited to only three decks but they also be four, five etc.

In one embodiment, the third deck comprises said bottling line 122 where the bottling of the liquid products into the receptacles in accordance to the received orders 107-109 takes place. The third deck may further comprise a label production line 123 for putting the labels along with the trademark in accordance to the received orders from the buyers 104-106 on the receptacles, a production line 124 for producing the labels along the trademarks of the buyers 104-106, a tap production line 125 adapted for producing the taps for the receptacles in accordance to the received orders from the buyers, a receptacle production line 126 adapted for producing the receptacles in accordance to the received orders from the buyers or a blowing factory adapted for producing the receptacles in accordance to the received orders from the buyers, an ingredients production line 127 for producing the ingredients to be used in making the receptacles such as small plastic balls, where the raw material from the container 128, in the hold of the ship contains the material necessary for this production.

In one embodiment, the second deck 120 of the vessel 100 comprises one or more unloading hatches 130a-130e for hosting bottled liquid that is ready to be delivered on destination address. This makes the loading of the liquid products much easier when the vessel reaches the destination address.

The communication means 102 can be any kind of a computer system or a fax and the like. The instructions 107-109 may include information indicating the type of liquid to be bottled, information relating to the label to be put on the receptacles along with the trademark, information indicating the destination of the bottled liquid, information indicating the volume of the receptacles and the type of liquid to be bottled, information indicating the external shape the receptacles and the type of liquid to be bottled, and barcoding including information indicating the retail price of the receptacles. This list is not exhaustive and the information can include all kinds of orders such as the colours of the receptacles, the time of when the bottling is supposed to start or finish and the like.

In one embodiment, the instructions are processed partly or totally in an automatic way such that the bottling is started automatically at some pre-determined time. In that way, the bottling can be partly or fully automated such that the manpower required on board of the vessel 100 is minimized. In one embodiment, the bottling line 122 comprises of special made liquid filling machines fitted on the vessel with plurality of liquid filling positions, each liquid filling position having a liquid filling device for filling the receptacles with a liquid product. These filling devices may have an apparatus designed to introduce a predetermined volume of liquid into the interior of the receptacles to a substantially predetermined volume of liquid product. The apparatus may further be adapted to terminate the filling of the liquid into the receptacles when a pre-determined level is reached in the receptacles. A conveyor may also be provided that is adapted to move receptacles, after being filled up to the pre-determined level to a closing station where the filled receptacles are closed.

As mentioned previously, all the bottling process, the type of receptacles and bottle material, the volume, whether or not labelling shall be done and the type of labelling with the trademark may be based on the orders 107-109 received from the external buyers 104-106.

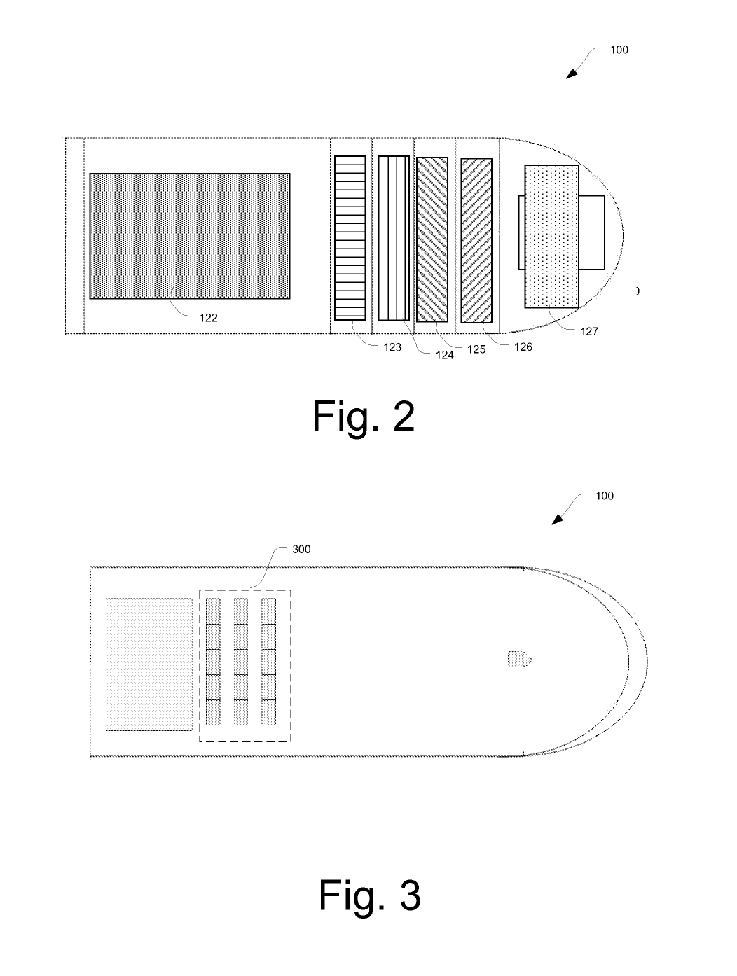

FIG. 2 show a top view of the third deck 121 of the vessel shown in FIG. 1, showing the bottling line 122 and the various production lines 123-127. Although these are depicted here as parallel arranges spaces. FIG. 3 shows a top view of the top deck showing a conveyor system 300 that adapted to convey bottles liquid from the vessel as claimed in any of the preceding claims to a destination harbour.

It should be noted that the arrangement of the decks as well as the location of said bottling line, the placement of where the bottled liquid products and the hatches can be different from what is being shown in FIGS. 1-3.

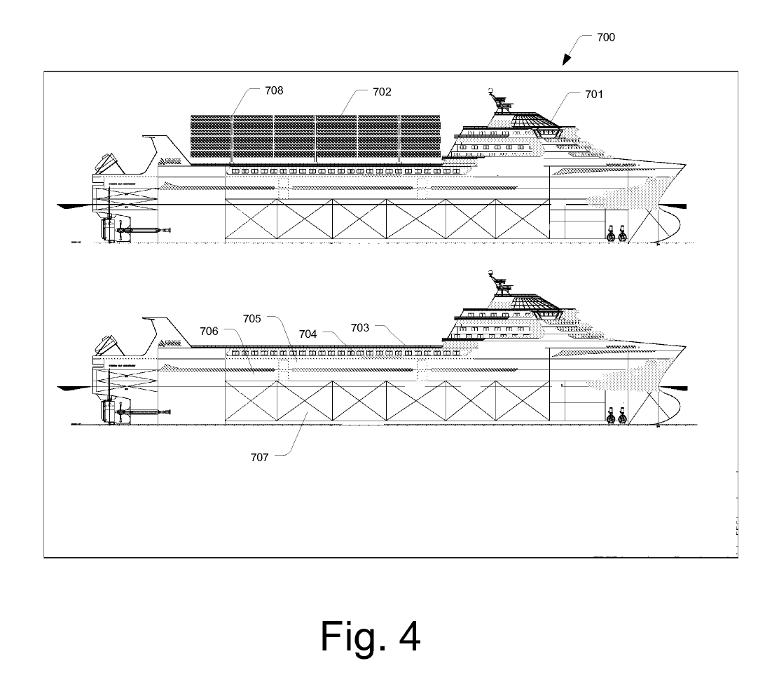

FIG. 4 shows another embodiment of a vessel 700 according to the present invention. In this embodiment, the wheelhouse 701 of the vessel is at the prow-side of the vessel 700 instead of at the poop-deck side as shown in FIG. 1. The vessel 700 comprises a first deck 703 as a top deck, a second deck 704 for hosting said liquid bottling line, a third deck 705 for hosting ready liquid products and a fourth deck 706 for also hosting ready liquid products and said one or more unloading hatches for unloading the ready liquid products. The second deck may further comprise one or more of said production lines selected from: receptacle production line adapted for producing the receptacles in accordance to the received orders from the buyers, a blowing factory adapted for producing the receptacles in accordance to the received orders from the buyers, tap production line adapted for producing the taps for the receptacles in accordance to the received orders from the buyers, label production line adapted for producing the labels along with the trademark in accordance to the received orders from the buyers and euro plastic pallets and plastic film production for packing.

In this embodiment, the vessel 700 further comprises a number of solar cells 702 arranged at the top deck 703 and mounted to posts 708. The role of the solar cells 702 is firstly to provide energy to the vessel 700, e.g. for running the engine of the ship and/or for providing energy to said vacuum distillation mechanism and/or said bottling plant and production lines, and secondly to act as sails where the surface of the solar cells 702 interacts with the winds for generating a thrust. The internal arrangement of the solar cells 702 with respect to the wind is preferably computer controlled e.g. based on input data for a wind meter so that the angle of the solar cells 702 with respect to the vertical posts may be tilted and/or rotated. Also, the solar cells 702 may be made of a number of a large number of sub-solar cells such that, when combined together, form the large surface area shown here, which plane shape may be adjusted so that it forms a substantially a flat plane and also a convex/concave plane. Accordingly, the orientation of the solar cells 702 may be continuously adapted to the wind orientation or the wind strength so as to enhance or reduce (when necessary) the generated thrust. Also, the internal orientation of the solar cells 702 may be adapted to be used for steering the vessel 700.

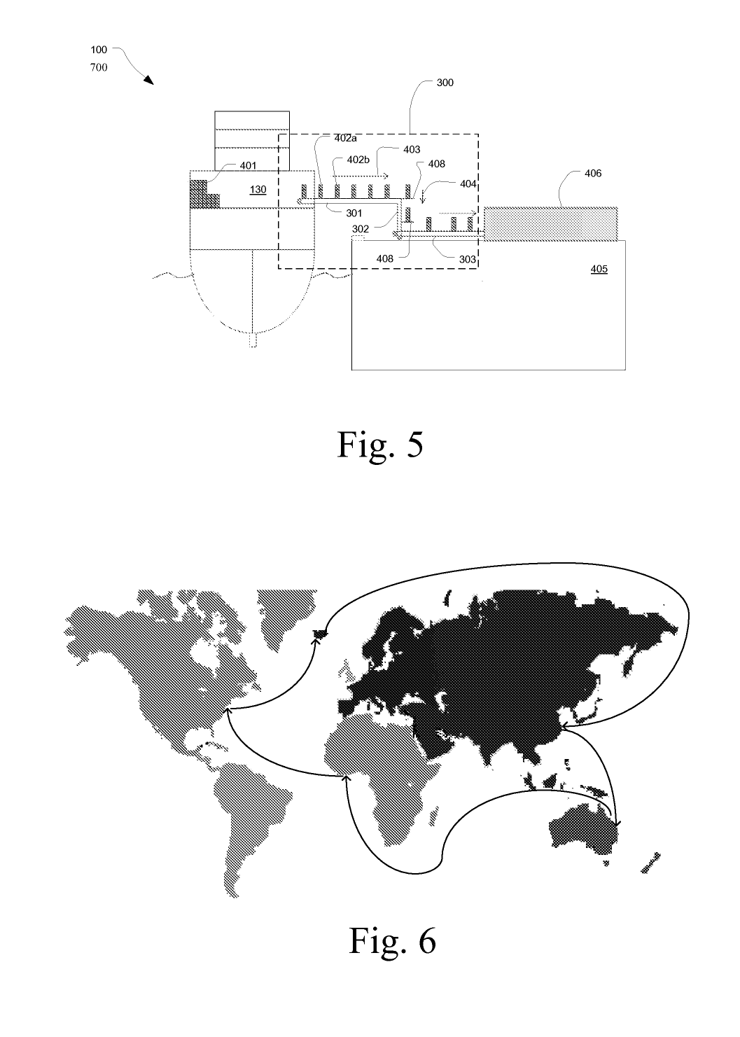

FIG. 5 shows in more details an embodiment of the conveyor system 300 during use for conveying the bottled liquid products from the vessel 100, 700 to the harbour 405 at the destination address. The conveyor system 300 comprises a horizontal conveyor portion 301 that defines a horizontal conveying path, and a vertical conveyor portion 302 interlinked to the horizontal conveyor portion 301 that defines a vertical conveying path. During use, the horizontal and the vertical conveyor portions form a step-like conveyor, where the first horizontal conveyor portion is moved and placed into one of the hatches 130 where the supplies 401 of the bottled liquid products are kept. Boxes with liquid products are stacked onto boards 402a, b which are placed onto the horizontal conveyor 301. The conveyor portions 301, 302 comprise multiple forks 408 (each fork or pair of fork interacts with a single board 402a or 402b) that move along a closed loop-conveying path showed with arrows 403, 404 (and back the same route), which convey the boards 402a,b stacked with the liquid products along the horizontal conveying path 403, and when the board reaches the end of the first conveyor portion 301 the forks moves vertically down 302 where it releases the board. The forks then move the same way back, i.e. opposite to the arrows 404, 403 and the process is repeated.

This is then repeated for the remaining hatches 130a-130d, simply by sliding or moving the conveying system to the next hatch or having conveying system for each hatch 130a-130e. It should be noted that there are no limits are on numbers of hatch or on numbers of conveying system 300.

In the embodiment shown here, a further third conveyor portion 303 is provided which is adapted to be connected to the end of the second conveyor portion 302. Accordingly, when the boards 402a,b with the liquid products reach the end of the second conveyor portion 302, they are received by the third conveyor portion 303 which conveys the boards 402a,b into e.g. a container 406.

FIG. 6 shows an example of possible route of a vessel 100, 700 as discussed previously, where the vessel 100, 700 receives orders from one or more liquid buyers 104-106 for bottling liquid, e.g. water, beer, juice, liquor, soft drink etc., where the route can e.g. be Iceland-Chine-Australia-Africa-USA-Iceland. Accordingly, the vessel acts as a moveable bottling plant for one or more types of liquids, that in addition of being capable of bottling various liquid products acts at the same time as a transport vessel. Thus, while sailing, the vessel 100 is capable of receiving various orders of bottling liquid product, and can thus with a great cost reduction bottle and transport the bottled liquid products to the destination. Thus, no additional bottling plants need to be built and run. As mentioned previously, a water buyer can sell water under a particular trademark. The water used can come from one or more locations, and be bottled under this particular trademark. Thus, this particular water buyers can establish a contact with the vessel 100, check whether they have sufficient water supplied on board, ask about the quality of the water and where it comes from. The buyer may e.g. require high quality water, or e.g. water processed from see which could mean that the price per bottle is lower. As an example, if the quality fulfils the quality requirement for this water buyer, he can send in an order of bottling e.g. 10.000 0.33 l plastic water receptacles, with their label/trademark, and request that this shipment is transported to New York. Accordingly, this particular water buyer does not need to built his own bottling station/factory, but instead create his own trademark and sell the water (beer etc) under this trademark.

As mentioned previously, if the water is processed from the see there is no need to pick it up at some location (e.g. sail to Iceland to get Icelandic water) which means that the costs per bottle will be reduced enormously. This makes it possible to transport much more of bottled water to third world countries than is being done today. So, this is not only a good economical solution but can also makes it possible the supply water for less price to third world countries where water is greatly needed.

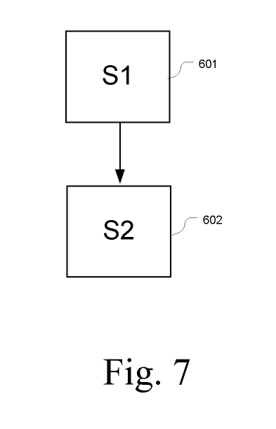

FIG. 7 an embodiment of a method according to the present invention bottling liquid products on board of said vessel.

In a first step (51) the method includes receiving orders from external liquid buyers 601 for bottling the liquid into the receptacles the orders including information indicating the type of liquid to be bottled and information indicating the destination of the bottled liquid. As discussed previously, these orders include detailed information about the order itself, e.g. information indicating the type of liquid to be bottled, information relating to the label to be put on the receptacles, information indicating the destination of the bottled liquid, information indicating the volume of the receptacles and the type of liquid to be bottled, and information indicating the external shape the receptacles and the type of liquid to be bottled, and information about the destination address of the order.

In a second step (S2) 602 the method includes bottling the liquid on board of the vessel in accordance to the received external orders in accordance to the received orders. Further details regarding the bottling of the liquid on board of the vessel has already been addressed in FIG. 1.

Certain specific details of the disclosed embodiment are set forth for purposes of explanation rather than limitation, so as to provide a clear and thorough understanding of the present invention. However, it should be understood by those skilled in this art, that the present invention might be practiced in other embodiments that do not conform exactly to the details set forth herein, without departing significantly from the spirit and scope of this disclosure. Further, in this context, and for the purposes of brevity and clarity, detailed descriptions of well-known apparatuses, circuits and methodologies have been omitted so as to avoid unnecessary detail and possible confusion.

Reference signs are included in the claims, however the inclusion of the reference signs is only for clarity reasons and should not be construed as limiting the scope of the claims.

1. A vessel adapted to be used as a moveable bottling plant for bottling liquid products, the vessel comprising:
a means for hosting liquid products,
a means for hosting empty receptacles or ingredients adapted for producing such receptacles,
a communication means adapted to receive external orders from external liquid buyers for bottling the liquid into the receptacles, and
a liquid bottling line adapted to bottle the liquid on board of the vessel in accordance to the received external orders.

2. The vessel according to claim 1, wherein the communication means is a computer system including a receiver for receiving the external orders, wherein the external orders include:
information indicating the type of liquid to be bottled,
information relating to the label and the trademark to be put on the receptacles,
information indicating the destination of the bottled liquid,
information indicating the volume of the receptacles and the type of liquid to be bottled,
information indicating the external shape the receptacles and the type of liquid to be bottled, and
barcoding including information indicating the retail price of the receptacles, or
a combination of one or more of the above.

3. The vessel according to claim 2, wherein the liquid product is selected from one or more of the following:
a water,
a soda water,
an alcohol containing drink,
a juice,
a food oil,
a beer,
a fish oil,
a soda cola, or
a soft drink.

4. The vessel according to claim 1, wherein the means for hosting the liquid products comprises multiple tanks arranged within the hold of the vessel.

5. The vessel according to claim 1, wherein the vessel comprises a first deck as a top deck, a second deck comprising one or more unloading hatches for hosting bottled liquid that is ready to deliver to the buyer of the liquid and a third deck for hosting a liquid bottling line.

6. The vessel according to claim 1, wherein the vessel comprises a first deck as a top deck, a second deck for hosting liquid bottling line, a third deck for hosting ready liquid products and a fourth deck for hosting ready liquid products and one or more unloading hatches for unloading the ready liquid products.

7. The vessel according to claim 5, wherein said second deck further comprises one or more production lines selected from:
a receptacle production line adapted for producing the receptacles in accordance with the received orders from the buyers,
a blowing factory adapted for producing the receptacles in accordance with the received orders from the buyers,
a tap production line adapted for producing the taps for the receptacles in accordance with the received orders from the buyers, or
a label production line adapted for producing the labels along with the trademark in accordance with the received orders from the buyers.

8. The vessel according to claim 1, wherein special made, water controllizer IWL 20-200 is mixed with the hosting liquid products so as to maintain pureness in the means for hosting liquid products.

9. The vessel according to claim 1, wherein the means for hosting the ingredients adapted for producing the receptacles is a tank arranged within the hold of the vessel and wherein the ingredient includes the raw material adapted to be used for producing the plastic material for producing plastic receptacles.

10. The vessel according to claim 1, further comprising a cooling mechanism integrated into the means for hosting liquid products for maintaining the liquid products at an optimal temperature.

11. The vessel according to claim 1, wherein the liquid product is water processed from a sea water and wherein an excess energy from the engine of the vessel is used for vacuum distillation of the sea water so as to convert it to drinkable water.

12. A conveyor system adapted to convey bottles of liquid from a vessel as claimed in claim 1 to a destination harbour, comprising:
a horizontal conveyor portion that defines a horizontal conveying path, and
a vertical conveyor portion adapted to be interlinked to the horizontal conveyor portion that defines a vertical conveying path,
wherein during use the horizontal and the vertical conveyor portions form a step-like conveyor, the first horizontal conveyor portion being adapted to be coupled to said one or more unloading hatches of the vessel and extends away from the vessel towards the harbour and wherein the vertical conveyor portion forms a vertical extension from the end of first conveyor portion to the harbour, wherein the conveyor portions comprise multiple forks that move along a closed loop conveying path defined via the conveyor portions such that forks interact with pallets or a similar means that carry the bottled liquid products and convey the liquid bottled products out of the hatches along the horizontal conveying path and subsequently along the vertical conveying path wherein the liquid in the bottles is released.

13. The conveyor system according to claim 12, wherein the conveyor system is an integral part of the vessel, or the conveyor system is kept separately on shore.

14. The conveyor system according to claim 12, wherein the horizontal and the vertical conveyor portions may be clamped together when not being used.

15. The conveyor system according to claim 12, further comprising a third conveyor portion adapted to be connected to the second conveyor portion for conveying the received bottled liquid products the second conveyor portion.

16. A method of bottling liquid products performed on board a vessel, as claimed in claim 1, comprising:
receiving orders from external liquid buyers for bottling the liquid into the receptacles the orders including information indicating the type of liquid to be bottled and information indicating the destination of the bottled liquid, and
bottling the liquid on board of the vessel in accordance to the received external orders and in accordance to the received orders.
